(19) United States
(12) Patent Application Publication
(10) Pub. No.: US 2010/0042671 A1
(43) Pub. Date: Feb. 18, 2010

(54) SERVER EMBEDDED IN DEVICE CHARGING CRADLE

(75) Inventors: Amrit Natt, Gilbert, AZ (US); Tom Bianculli, Manorville, NY (US); Mark Clayton, Manorville, NY (US); Leo Greeley, Shoreham, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/191,754

(22) Filed: Aug. 14, 2008

(51) Int. Cl. G06F 15/16; H01H 1/00; H04M 1/00

(52) U.S. Cl. 709/203; 455/573; 455/557

(57) ABSTRACT

A charging cradle having an embedded server, wherein the server software is a ubiquitous and integral part of the charging cradle. Additionally, the server enables monitoring of an enterprise mobile device for battery level and availability, and can push software/firmware updates to the mobile device via an integrated data connection. Furthermore, the charging cradle can distribute services to the mobile devices, reducing the overall complexity of the mobile devices.

### BACKGROUND

Wireless communication technology has experienced significant growth over the past several years. This growth has lead to wireless systems with increased sophistication, computing power, and storage capability. This is particularly true for enterprise wireless communication systems where a backend server can be used to provide services to the frontend devices. However, as the sophistication of the enterprise wireless systems has increased, so has the complexity of the backend servers necessary to provide the services.

Enterprise wireless system customers often do not want a traditional physical server on site. Typically, servers can require intensive technical support, as well as substantial cost to implement and maintain. Additionally, in some situations the footprint of a traditional server makes it impractical. While, it is desirable to have a backend system provide services to the frontend devices it does not necessarily have to be a traditional server.

Along with the increase in wireless communication technology there has also been an equivalent or greater increase in computing technology. The size of advanced and powerful computing systems in constantly decreasing. Additionally, the cost of such compact computing systems has also decreased rapidly. Therefore, it would be desirable to have a system that maintained the functionality of a backend server that can provide services to the frontend devices in a smaller, easier to maintain, and less expensive package than a traditional server.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more embodiments and corresponding disclosure thereof, various aspects are described in connection with a server embedded in a charging cradle. In accordance with some aspects presented herein, provided is a charging cradle having an embedded server, a plurality of charging slots disposed on the charging cradle, wherein the charging slots include a charging connection that provides power to recharge a mobile device inserted in one of the charging slots. Additionally, a set of computer executable server instructions that are deployed on the server facilitate communication between the server and the mobile devices.

According to another aspect, an apparatus is disclosed having an embedded server operative to execute a set of server instructions; the server instructions include an operating system. A plurality of charging slots are disposed to the apparatus, wherein the charging slots include a charging connection and a data connection, the charging connection provides power to recharge a mobile device inserted in one of the charging slots, and the data connection provides a direct data link between the server and the mobile device. In addition, a data store maintains at least one of a set of authorization data, at least one service, or data acquired from a mobile device via the USB connection. A fingerprint scanner images a user's fingerprint to verify authorization to use a mobile device associated with the apparatus, and an Ethernet port provides communication between the cradle and a communication framework.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a generalized block diagram of a charging cradle with an embedded server;

FIG. 2 illustrates a generalized block diagram of a charging cradle with an embedded server;

FIG. 3 illustrates an exemplary docking station having an embedded server;

FIG. 4 illustrates a system that employs an artificial intelligence component that facilitates automating one or more features in accordance with the subject disclosure;

FIG. 5 illustrates a block diagram of a computer operable to execute the disclosed embodiments;

FIG. 6 illustrates an exemplary device operative to execute the one or more embodiments disclosed herein; and

FIG. 7 is a schematic block diagram illustrating a suitable operating environment in accordance with an aspect of the subject disclosure.

### DETAILED DESCRIPTION

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed embodiments.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used.

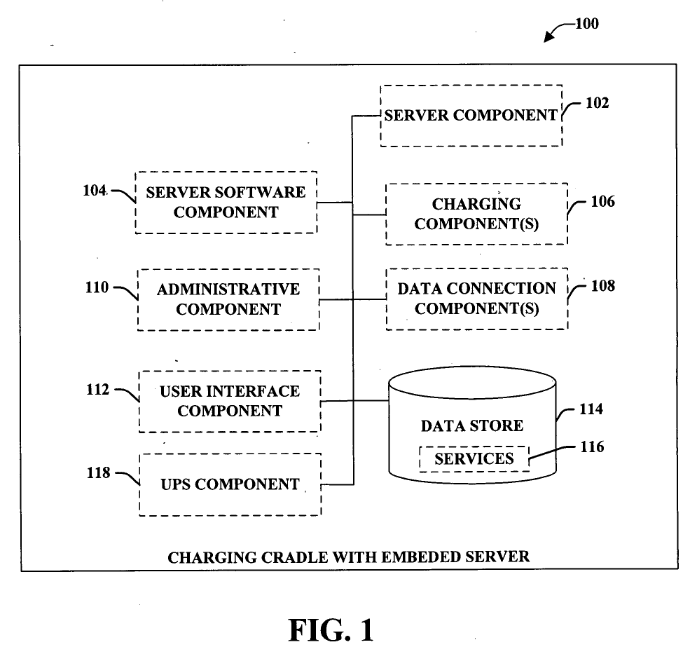

Referring initially to FIG. 1, a mobile device charging system 100 with an embedded server is illustrated in accordance with an aspect of the present innovation. The system 100 includes a server component 102, a server software component 104, a set of charging components 106, a set of data connections 108, an administrative component 110, a user interface component 112, a data store 114, and at least one associated mobile client (not shown).

The server component 102 (hereinafter ‘server’) is embedded in a mobile device charging cradle (discussed infra). The server component 102 can be hardware and/or software (e.g., threads, processes, computing devices). The server 102 can house threads to perform transformations by employing the innovation, for example. One possible communication between the mobile clients (discussed infra) and the server 102 can be in the form of a data packet adapted to be transmitted between two or more computer processes. The data packet may include a cookie and/or associated contextual information, for example. The system 100 can include connectivity to a communication framework (e.g., a global communication network such as the Internet) that can be employed to facilitate communications between the mobile client (e.g. mobile device associated with the system) and the server 102.

The server software component 104 (hereinafter ‘server software’) is deployed on the server 102. The server software 104 facilitates communication between the server 102 and one or more mobile clients. In addition, the server software 104 can facilitate communication between the server 102 and the communication framework.

The mobile clients include a power source, and typically the power source is a battery. The charging components 106 physically connect to the mobile clients, wherein the charging components 106 provide a voltage and a current (e.g. power) to the mobile client that replenishes the battery. Additionally or alternatively, the charging components 106 can physically connect to one or more batteries independent of the mobile client, wherein the charging components 106 can provide power to recharge the batteries. For instance, users can charge a plurality of batteries either by connecting the mobile clients to the charging components 106, and/or connecting only the batteries to the charging components 106.

In addition, the system 100 can include a set of data connection components 108 (hereinafter ‘data connections’) that provide data connectivity to the mobile clients. The data connections 108 enable the server software 104 to continuously monitor the mobile clients, update software on the mobile clients, and also assign a mobile client to a user when the user logs in to the system 100 (discussed infra). The data connections 108 connect to the mobile clients and can include any manner of transferring data between two or more devices, such as wired connections (e.g. USB communication, serial communication, parallel communication, fire wire, proprietary connection systems, etc.), or wireless connections (e.g. 802.11, inductive communication, light communication, infrared communication, Wi-Fi communication, etc.). Consequently, the data connections 108 can ensure communication with the mobile client even when the device does not have enough battery power, a correct security key, or a working network layer.

The administrative component 110 provides for administration of the system 100 by an administrator. The administrator can connect to the system 100 via plurality of ways, including a direct data link (e.g. wired connection), via the user interface component 112 (discussed below), a wireless connection (e.g. internet, Bluetooth, WLAN, etc.), and so forth. For instance, the administrator can connect a computer (e.g. laptop, desktop, mobile device, smart phone, PDA, etc.) to the system 100 via a wired connection, and interact with the server software 104 via the administrative component 110. The administrator can update software, view system data, modify authentication data, modify network connectivity data, etc.

The user interface component 112 enables interaction between users and the system 100. The user interface component 112 can provide a set of system indicators that inform users of system processes (e.g. system status, user messages, mobile client status). For instance, the system indicators could be provided to the users via a liquid crystal display (LCD) screen. Additionally, the user interface component 112 can obtain user input. The user input can include explicit user inputs (e.g., configuration selections, question/answer) such as from keypad selections, optical scanners, fingerprint scanners, mouse selections, keyboard selections, speech, and so forth.

The data store 114 can be a persistent (e.g. hard drive, flash memory, etc.) or removable (e.g. CF cards, SD cards, flash memory, etc.) computer readable medium operative to store computer executable instructions. Data (e.g. contact list, mobile device status, etc.) from the mobile clients can be transferred to the system 100 and maintained in the data store 114. In addition, the data store 114 maintains one or more services 116 associated with the system 100 and/or the mobile clients. For instance, the services can include security/authentication services (e.g. authentication list, logins, etc.), and functionality services (e.g. GPS, calendars, preferences, applications, etc.). The server software 104 can provide access to the services for the mobile clients via the data connections 108 or via a wireless link, wherein the mobile clients can leverage the services. Additionally, new services 116 can be acquired via the communication framework.

The system 100 can also include an uninterruptable power supply (UPS) component 118. The UPS component 118 provides power to the system 100 in case of power failure or disturbance. The UPS component 118 can include a plurality of power sources, including but not limited to a rechargeable battery (e.g. lithium ion battery, etc.). The server software 104 can monitor the charge state of the UPS component 118, and instruct the system 100 to charge the UPS component 118 as necessary or desired.

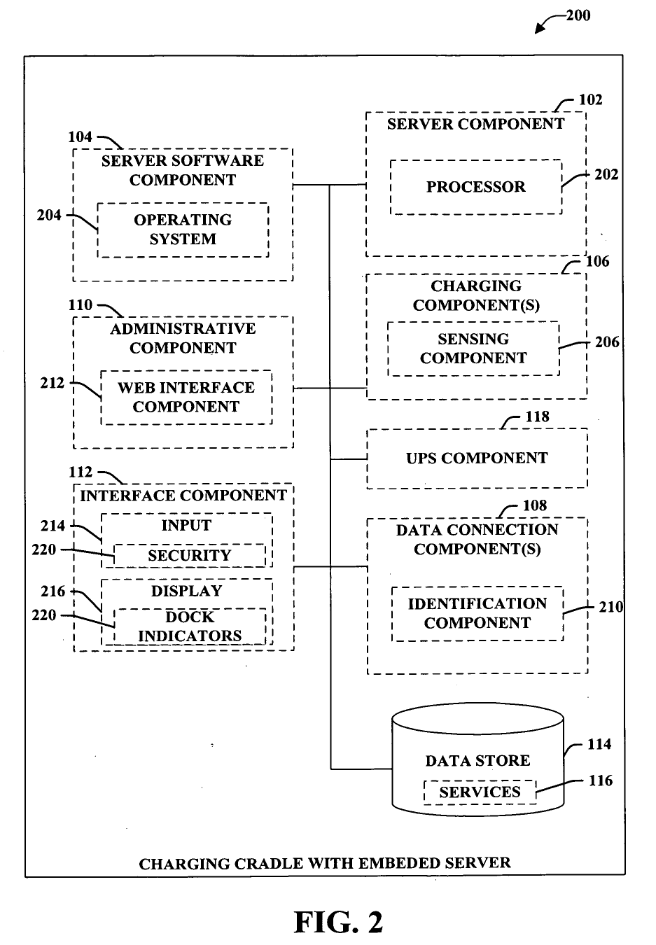

Referring to FIG. 2, a mobile device charging system 200 with an embedded server is illustrated in accordance with an aspect of the present innovation. The system 200 includes a server component 102, a server software component 104, a set of charging components 106, a set of data connections 108, an administrative component 110, a user interface component 112, a data store 114, a UPS component 118, and at least one associated mobile client (not shown).

The server 102 includes a processor 202. The processor 202 is programmed to control and operate the various components within the system 200 in order to carry out the various functions described herein. The processor 202 can be any of a plurality of suitable processors, such as an ARM processor. The manner in which the processor 202 can be programmed to carry out the functions relating to the innovation will be readily apparent to those having ordinary skill in the art based on the description provided herein.

As previously noted, the server software component 104 is deployed on the server 102. The server software 104 can include an operating system 204. The operating system 204 is responsible for the management and coordination of activities and the sharing of the resources of the system 200. It is to be appreciated that the innovation can be implemented with various commercially available operating systems, such as Linux, and/or various combinations of operating systems. Additionally, the server software 104, including the operating system 204, can be maintained in the data store 114.

The system 200 includes at least one charging component 106 per charging dock, wherein a dock is adapted to receive a mobile client and/or battery and connect the mobile client or battery to the charging component 106 (discussed infra). The charging components 106 can include a sensing component 206. The sensing component 206 can detect the presence of a mobile client or battery coupled to the charging component 106 (e.g. a mobile client placed in the dock), and can detect the charge state of the connected power source (e.g. battery). Additionally or alternatively, the mobile client can report its charge state to the server software 104 via a data connection 108 or a wireless link (e.g. 802.11).

The sensing data can be communicated to the server software 104, wherein the server software 104 can implement one or more predetermined policies based on the sensing data. For instance, the server software 104 can direct the charging component 106 to discontinue charging the connected mobile client when the battery is fully charged. In addition, the server software 104 can instruct the user interface component 112 to display information regarding the charge state of the connected mobile client.

The system 200 includes at least one data connection component 108. Additionally or alternatively, the system 200 can include at least one data connection component 108 per dock. The data connection component 108 can include an identification component 210 that can identify the mobile client presently placed in the dock. For instance, the identification component 210 can identify a connected mobile client by its unique identifier (e.g. serial number, inventory number, device name, etc.). The identifier can be communicated to the server software 104, wherein the server software 104 can implement one or more policies based on the identifier. For instance, the server component 104 can determine the presence of an employee at a worksite based on the identification of the mobile client that was previously assigned to the employee.

The administrative component 110 enables an administrator to modify, control, define, etc. any of a plurality of policies implemented by the server software 104 and/or services 116 maintained in the data store 114. The administrative component 110 can include a web interface component 212 that provides for administrator interaction with the system 200 via a series of internet based graphical user interfaces (GUI). The administrator can connect to the internet based GUI using an internet enabled computer (e.g. laptop, desktop, mobile device, smart phone, PDA, etc.), wherein one or more interfaces can be exposed to facilitate administration of the system 200. The web interface component 212 can obtain the administration data from the internet based GUI via the communication framework (previously discussed). The administration data can be communicated to the server software 104.

The user interface component 112 facilitates user interaction with the system 200, and can include an input component 214, and a display component 216. The input component 214 can obtain user input via a plurality of manners, including explicit user inputs (e.g., configuration selections, question/answer) such as from keypad selections, optical scanners, fingerprint scanners, mouse selections, keyboard selections, speech, and so forth. In addition, the input component 214 can include a security component 220. The security component 220 can verify user input against a set of security data (e.g. authentication data, etc.) maintained in the data store 114 or remotely. For instance, a user may enter a password via a keypad to checkout (e.g. activate) a mobile client present in one of the docks, wherein the security component 220 will verify the password by comparing it to the passwords stored in the data store 114. The security component 220 can communicate the disposition of the password verification to the server software 104.

As noted, the user interface component 112 further includes one or more display components 216. The display component 216 displays relevant system data to users, such as system status (e.g. OK, error code, etc.), mobile client information (e.g. devices currently online), user login messages (e.g. login failed, login successful, etc.). The display component 216 can be comprised of any of a plurality of well known display devices, such as a liquid crystal display (LCD) screen, or a set of light emitting diodes (LEDs). Furthermore, the relevant system data to be displayed can be defined by the server software 104.

Additionally, the display component 216 can include at least one dock indicator component 218 (hereinafter ‘dock indicator’) for one or more docks included in the system 200. The dock indicators 216 indicate (e.g. display) the status of the mobile client connected to the dock, and can include but are not limited to one or more light emitting diodes (LED.), light bulbs, etc. For example, the dock indicators 218 can include a multicolor LED for each dock, wherein the LED displays a different color depending on the current status of the connected mobile client (e.g. blue when charging, green when the device is ready, red during firmware/software updating, etc.) As previously discussed, the charge status of the connected mobile client can be determined via the sensing component 206 or data transfer from the mobile client. In addition, the server software 104 can notify the dock indicators 218 when a data transfer is occurring with the mobile client.

In addition, the system, 200 can include an uninterruptable power supply (UPS) or battery backup 208. The UPS component 208 provides power for the system 200 in case of a power interruption. The system 200 can provide a voltage and a current to the UPS component 208 as necessary, and monitor the charge state of the UPS component 208. The charge state of the UPS component 208 can also be communicated to the server software 104, wherein the server software 104 can implement one or more predefined policies based on the charge state of the UPS component 208.

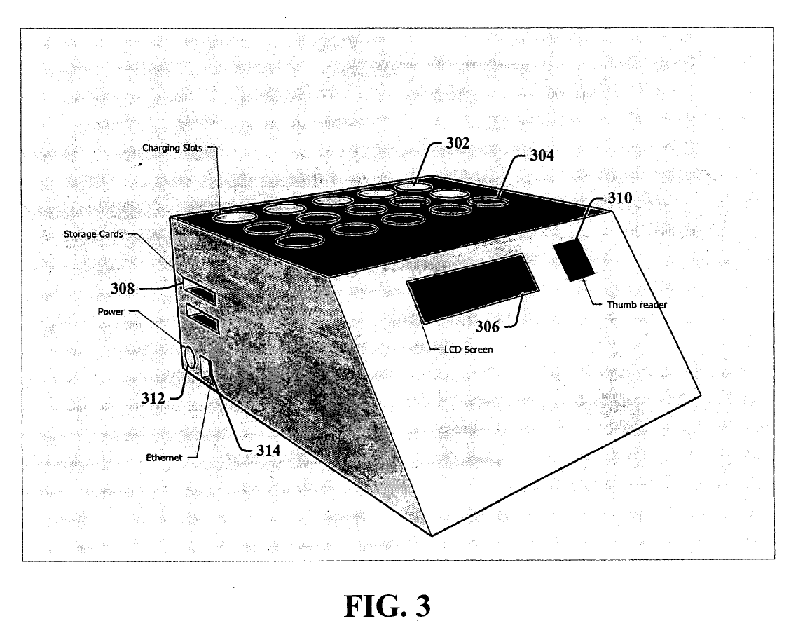

Referring to FIG. 3, an exemplary application of a mobile device docking station 300 with an embedded server is illustrated in accordance with an aspect of the present innovation. It is to be understood that the docking station shown and described is merely exemplary and other embodiments can be utilized in accordance with the subject disclosure. The docking station 300 includes a plurality of charging slots 302, a plurality of LED rings 304, an LCD screen 306, at least one storage card 308, a fingerprint scanner 310, a power receptacle 312, and a network connection 314.

The charging slots 302 (e.g. docks) are adapted to receive a mobile client (e.g. mobile device) having a rechargeable battery, or an autonomous rechargeable battery. A mobile client or battery placed in the charging slot 302 is connected to a charging source that provides an appropriate voltage and current (e.g. power) required to charge the battery. In addition, mobile clients placed in the charging slot 302 can be connected to a data connection (e.g. USB) that facilitates communication between a server embedded in the docking station 300 and the mobile clients. As noted previously, the data connections enable server software (see FIGS. 1 and 2) to continuously monitor the mobile clients, update software on the mobile clients, and also assign a mobile client to a user when the user logs in. Moreover, the data connections included in the charging slots 302 ensure communication with the mobile client even when the device does not have enough battery power, a correct security key, or a working network layer.

The docking station 300 has an LED ring 304 (e.g. dock indicator) for each charging slot 302. The LED rings encompass the charging slots 302, and emit visible light based on a status of a mobile client inserted into the charging slot 302. For instance, the LED rings 304 can emit visible light using a multicolor LED, wherein the LED displays a different color depending on the current status of the connected mobile client (e.g. blue when charging, green when the device is ready, red during firmware/software updating, etc.).

The LCD screen 306 (e.g. display component) displays relevant docking station 300 data, such as system status (e.g. OK, error code, etc.), mobile client information (e.g. devices currently online), and/or user login messages (e.g. login failed, login successful, etc.). The relevant docking station 300 data can be determined by the server software (see FIGS. 1 and 2).

The storage cards 308 (e.g. CF Cards, SD Cards, flash memory, etc.) function as data stores for the embedded server, wherein the storage cards 308 maintain computer executable instructions that can be implemented by the docking station 300. Also, data (e.g. contact list, mobile device status, etc.) from the mobile clients can be transferred to the docking station 300 and maintained (e.g. backed up) on the storage cards 308. Using a removable storage medium, such as the storage cards 308 provides for efficient replacement in the event of a failure, which militates against downtime. In addition, the storage cards 308 maintain one or more services associated with the docking station 300 and/or the mobile clients. For instance, the services can include security/authentication services (e.g. authentication list, logins, etc.), and functionality services (e.g. text-to-speech, voice recognition, GPS, calendars, preferences, applications, etc.). Maintaining services on the storage cards 308 can reduce the required processing and storage capability of the mobile clients, because the services can be centralized on the docking station 300, and access to the services can be provided to the mobile clients via the embedded server. For instance, instead of having to equip each mobile client with text-to-speech capabilities, the text-to-speech capabilities can be centralized at the docking station 308, and the mobile clients can leverage the text-to-speech capabilities. Additionally or alternatively, the docking station 300 can include persistent internal memory, such as a hard drive, flash memory, etc.

The fingerprint scanner 310 is adapted to scan at least one human finger (e.g. thumb, index finger, etc.). A user places their finger on the fingerprint scanner 310, and the fingerprint scanner 310 images the user's fingerprint to authenticate their privilege to use a mobile client associated with the docking station 300. The server software can verify the user's privileges by comparing the imaged fingerprint with an authentication source (e.g. list, database, etc.) maintained on the storage cards 308. In addition, the server software can instruct the LCD screen 306 to display a login status (e.g. successful, failed, etc.). Subsequently, if the user is authenticated the server software can assign a mobile client to the user, and instruct the LED ring 304 encompassing the charging slot 302 containing the mobile client to display an appropriate indicator (e.g. green for ready).

The power receptacle 312 is adapted to connect the docking station 300 to a power source (e.g. wall outlet) via a power cable, wherein the power source provides the input power required to operate the docking station 300. The input power is converted into the current and voltage necessary to power the charging slots 302. Additionally, the input power can be converted in order to re-charge a UPS (see FIG. 2) included in the docking station 300.

The network connection 314 enables communication between the docking station 300 and a communication framework (e.g. global communication framework such as the internet). For instance, the network connection 314 can be an Ethernet port which provides for a wired connection to an access point. Additionally or alternatively, the network connection 314 can be a wireless internet card that enables connection to a wireless access point. As previously discussed, communication with the communication framework enables new services to be acquired by the docking station 300, and administration of the docking station 300 can be accomplished via the network connection (see FIGS. 1 and 2).

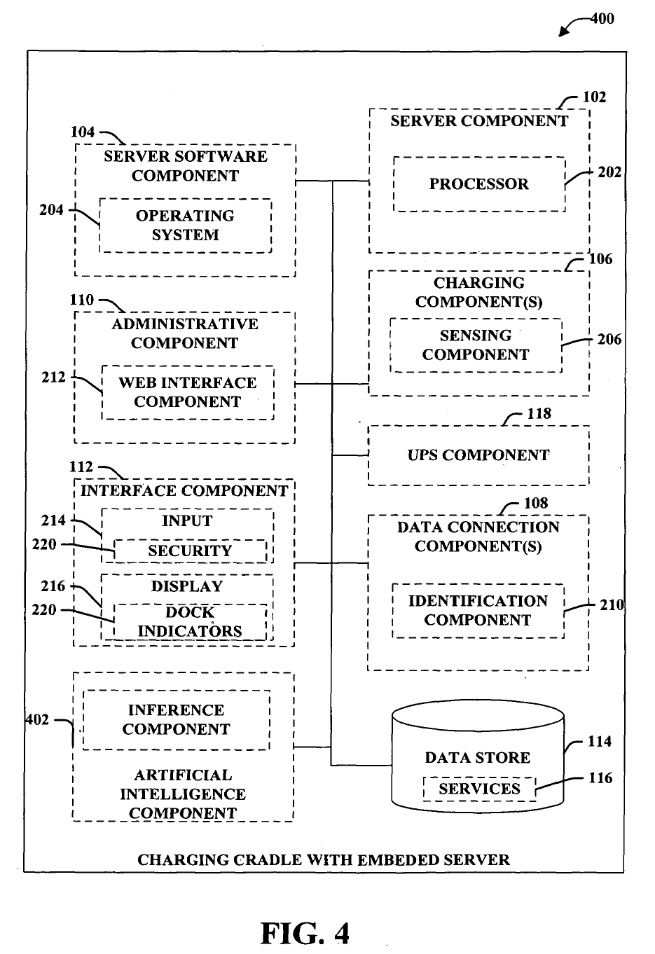

FIG. 4 illustrates a system 400 that employs an artificial intelligence (AI) component 402 that facilitates automating one or more features in accordance with the subject innovation. The subject innovation (e.g., in connection with inferring) can employ various AI-based schemes for carrying out various aspects thereof. For example, a process for providing access to services for the mobile clients can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to update or refine the previously inferred schema, tighten the criteria on the inferring algorithm based upon the kind of data being processed (e.g., financial versus non-financial, personal versus non-personal, . . . ), and at what time of day to implement tighter criteria controls (e.g., in the evening when system performance would be less impacted).

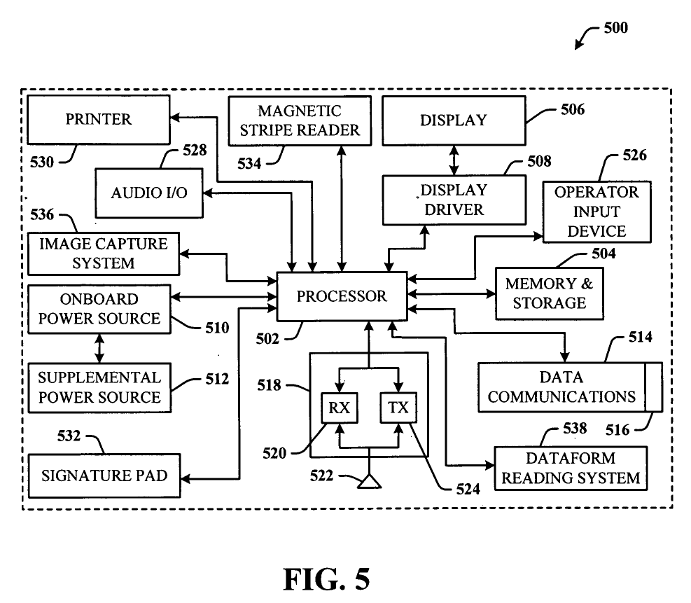

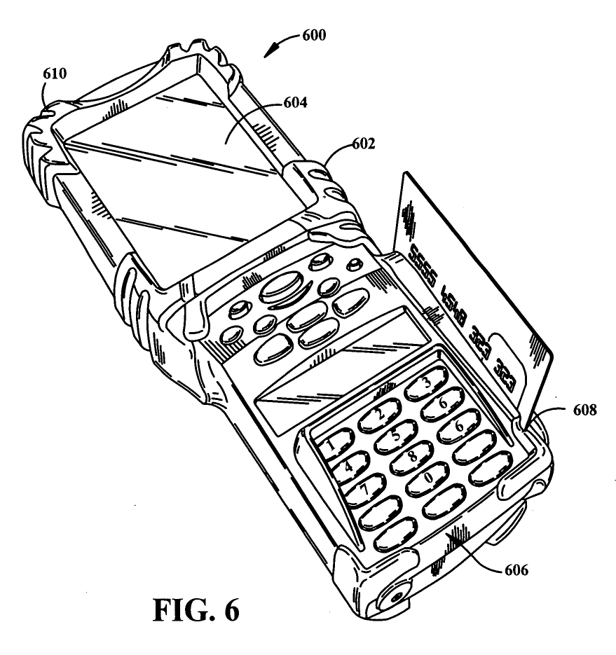

Referring now to FIG. 5, illustrated is a schematic block diagram of a portable hand-held terminal device 500 (similar to the portable device 600 as illustrated in FIG. 6) according to one aspect of the innovation, in which a processor 502 is responsible for controlling the general operation of the device 500. The processor 502 is programmed to control and operate the various components within the device 500 in order to carry out the various functions described herein. The processor 502 can be any of a plurality of suitable processors. The manner in which the processor 502 can be programmed to carry out the functions relating to the innovation will be readily apparent to those having ordinary skill in the art based on the description provided herein.

A memory 504 connected to the processor 502 serves to store program code executed by the processor 502, and serves as a storage means for storing information such as user credential and receipt transaction information and the like. The memory 504 can be a nonvolatile memory suitably adapted to store at least a complete set of the information that is displayed. Thus, the memory 504 can include a RAM or flash memory for high-speed access by the processor 502 and/or a mass storage memory, e.g., a micro drive capable of storing gigabytes of data that comprises text, images, audio, and video content. According to one aspect, the memory 504 has sufficient storage capacity to store multiple sets of information, and the processor 502 could include a program for alternating or cycling between various sets of display information.

A display 506 is coupled to the processor 502 via a display driver system 508. The display 506 can be a color liquid crystal display (LCD), plasma display, or the like. In this example, the display 506 is a ¼ VGA display with sixteen levels of gray scale. The display 506 functions to present data, graphics, or other information content. For example, the display 506 can display a set of customer information, which is displayed to the operator and can be transmitted over a system backbone (not shown). Additionally, the display 506 can display a variety of functions that control the execution of the device 500. The display 506 is capable of displaying both alphanumeric and graphical characters.

Power is provided to the processor 502 and other components forming the hand-held device 500 by an onboard power system 510 (e.g., a battery pack). In the event that the power system 510 fails or becomes disconnected from the device 500, a supplemental power source 512 can be employed to provide power to the processor 502 and to charge the onboard power system 510. The processor 502 of the device 500 induces a sleep mode to reduce the current draw upon detection of an anticipated power failure.

The terminal 500 includes a communication subsystem 514 that includes a data communication port 516, which is employed to interface the processor 502 with a remote computer. The port 516 can include at least one of Universal Serial Bus (USB) and IEEE 1394 serial communications capabilities. Other technologies can also be included, for example, infrared communication utilizing an infrared data port.

The device 500 can also include a radio frequency (RF) transceiver section 518 in operative communication with the processor 502. The RF section 518 includes an RF receiver 520, which receives RF signals from a remote device via an antenna 522 and demodulates the signal to obtain digital information modulated therein. The RF section 518 also includes an RF transmitter 524 for transmitting information to a remote device, for example, in response to manual user input via a user input device 526 (e.g., a keypad) or automatically in response to the completion of a transaction or other predetermined and programmed criteria. The transceiver section 518 facilitates communication with a transponder system, for example, either passive or active, that is in use with product or item RF tags. The processor 502 signals (or pulses) the remote transponder system via the transceiver 518, and detects the return signal in order to read the contents of the tag memory. In one implementation, the RF section 518 further facilitates telephone communications using the device 500. In furtherance thereof, an audio I/O section 528 is provided as controlled by the processor 502 to process voice input from a microphone (or similar audio input device) and audio output signals (from a speaker or similar audio output device).

In another implementation, the device 500 can provide voice recognition capabilities such that when the device 500 is used simply as a voice recorder, the processor 502 can facilitate high-speed conversion of the voice signals into text content for local editing and review, and/or later download to a remote system, such as a computer word processor. Similarly, the converted voice signals can be used to control the device 500 instead of using manual entry via the keypad 526.

Onboard peripheral devices, such as a printer 530, signature pad 532, and a magnetic strip reader 534 can also be provided within the housing of the device 500 or accommodated externally through one or more of the external port interfaces 516.

The device 500 can also include an image capture system 536 such that the user can record images and/or short movies for storage by the device 500 and presentation by the display 506. Additionally, a dataform reading system 538 is included for scanning dataforms. It is to be appreciated that these imaging systems (536 and 538) can be a single system capable of performing both functions.

FIG. 6 is provided to assist in understanding and to provide context to an embodiment of the innovation. Specifically, FIG. 6 illustrates an example of a handheld terminal 600 operative to execute the systems and/or methods disclosed herein. It is to be understood that the handheld terminal shown and described is merely exemplary and other devices can be utilized in accordance with the subject disclosure.

The handheld terminal 600 can include a housing 602, which can be constructed from a high strength plastic, metal, or any other suitable material. The handheld terminal 600 can also include a display 604. As is conventional, the display 604 functions to display data or other information relating to ordinary operation of the handheld terminal 600 and/or mobile companion (not shown). For example, software operating on the handheld terminal 600 and/or mobile companion can provide for the display of various information requested by the user.

Additionally, the display 604 can display a variety of functions that are executable by the handheld terminal 600 and/or one or more mobile companions. The display 604 can provide for graphics based alphanumerical information such as, for example, the price of an item requested by the user. The display 604 can also provide for the display of graphics such as icons representative of particular menu items, for example. The display 604 can also be a touch screen, which can employ capacitive, resistive touch, infrared, surface acoustic wave, or grounded acoustic wave technology.

The handheld terminal 600 can further include user input keys 606 for allowing a user to input information and/or operational commands. The user input keys 606 can include a full alphanumeric keypad, function keys, enter keys, etc. The handheld terminal 600 can also include a magnetic strip reader 608 or other data capture mechanism (not shown). An electronic signature apparatus can also be employed in connection with the magnetic strip reader or a telecheck system.

The handheld terminal 600 can also include a window 610 in which a bar code reader/bar coding imager is able to read a bar code label, or the like, presented to the handheld terminal 600. The handheld terminal 600 can include a light emitting diode (LED) (not shown) that is illuminated to reflect whether the bar code has been properly or improperly read. Alternatively, or additionally, a sound can be emitted from a speaker (not shown) to alert the user that the bar code has been successfully imaged and decoded. The handheld terminal 600 can also include an antenna (not shown) for wireless communication with a radio frequency (RF) access point; and an infrared (IR) transceiver (not shown) for communication with an IR access point.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

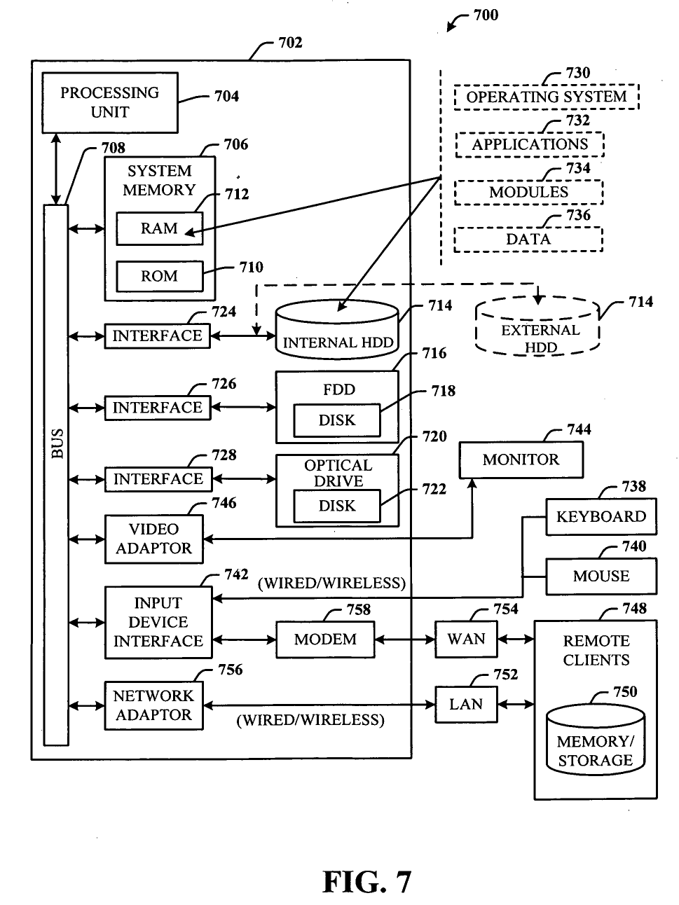

With reference again to FIG. 7, there is illustrated an exemplary environment 700 for implementing various aspects of the innovation that includes an exemplary server 702, the server 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the server 702, such as during start-up. The RAM 712 can also include a high-speed RAM such as static RAM for caching data.

The server 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the server 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the innovation can be implemented with various commercially available operating systems or combinations of operating systems.

A user can enter commands and information into the server 702 through one or more wired/wireless input devices, e.g., a keyboard 738 and a pointing device, such as a mouse 740. Other input devices (not shown) may include a microphone, an IR remote control, a joystick, a keypad, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a server can typically include other peripheral output devices (not shown), such as speakers, printers, etc.

The server 702 may operate in a networked environment using logical connections via wired and/or wireless communications to one or more remote clients, such as a remote client(s) 748. The remote client(s) 748 can be a mobile device, a workstation, a server computer, a router, a personal computer, portable computer, microprocessor-based entertainment appliance, a peer device or other common network node, and typically includes many or all of the elements described relative to the server 702, although, for purposes of brevity, only a memory storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices, and companies, and facilitate enterprise-wide computer networks, such as intranets, all of which may connect to a global communication network, e.g., the Internet.

When used in a LAN networking environment, the server 702 is connected to the local network 752 through a wired and/or wireless communication network interface or adapter 756. The adaptor 756 may facilitate wired or wireless communication to the LAN 752, which may also include a wireless access point disposed thereon for communicating with the wireless adaptor 756.

When used in a WAN networking environment, the server 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the server 702, or portions thereof, can be stored in the remote memory/storage device 750. It will be appreciated that the network connections shown are exemplary and other means of establishing a communications link between the computers or devices can be used.

The server 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile device communication system, comprising:
a charging cradle having an embedded server, and at least one associated mobile device;
at least one charging slot included in the charging cradle, wherein the charging slots are adapted to connect to at least one of a mobile device having a rechargeable battery, or a rechargeable battery, and the charging slots provide power to recharge the batteries; and
a set of computer executable server instructions that are deployed on the server, wherein the server instructions facilitate communication between the server and the mobile devices.

2. The system of claim 1, wherein the set of computer executable server instructions include at least one operating system, the operating system is responsible for the management and coordination of activities and the sharing of the resources of the system.

3. The system of claim 2, wherein the operating system is at least one of Linux, or Linux based.

4. The system of claim 1, wherein the charging cradle further includes at least one data connection component that provides for a data link with at least one associated mobile device.

5. The system of claim 1, further comprising a data store that maintains at least one of a set of services, or data obtained from the mobile devices.

6. The system of claim 5, wherein the server can provide access to the services maintained in the data store to at least one associated mobile device, and the mobile device can use the services.

7. The system of claim 1, further comprising an interface component that facilitates user interaction with the system.

8. The system of claim 7, wherein the interface component includes a display component that displays system data to the users.

9. The system of claim 8, wherein the system data includes at least one of a set of mobile device information, one or more user login messages, or a system status.

10. The system of claim 7, wherein the interface component includes at least one charging slot indicator, the charging slot indicators indicate the status of the mobile devices inserted in the charging slots.

11. The system of claim 10, the status of the mobile device includes at least one of charging, ready, updating, or not ready.

12. The system of claim 10, wherein the charging slot indicator is at least one of a light emitting diode (LED), a multicolor LED, a LCD screen, or a LED ring that encompasses at least one charging slot.

13. The system of claim 7, wherein the interface component includes an input component that enables user input.

14. The system of claim 13, the input component is at least one of a keypad, a microphone, an optical scanner, or a fingerprint scanner.

15. The system of claim 13, the input component includes a security component that verifies a user authorization to use a mobile device associated with the charging cradle by comparing user input with an authorization source, wherein the authorization source can be maintained locally or remotely.

16. The system of claim 1, wherein the server includes an ARM processor.

17. The system of claim 1, wherein each charging connection includes a sensing component that senses the presence of mobile device in the charging slot and the charge state of the mobile device.

18. The system of claim 1, wherein the sensing component can communicate to server instructions at least one of the presence or charge state.

19. The system of claim 1, wherein the charging cradle includes a backup battery that provides power to the cradle in case of an interruption of power.

20. The system of claim 1, wherein the data connection includes an identification component that can identify the mobile device inserted in the charging slot, and communicates the identity of the mobile device to the server software component.

21. The system of claim 1, further comprising an administrative component that provides for administration of the server software.

22. The system of claim 21, wherein the administration of the server software is accomplished via a set of graphical user interfaces on a remote terminal, the remote terminal is connected to the charging cradle via at least one of a wireless link, a network connection, or a wired connection.

23. The system of claim 1, further comprising an artificial intelligence component that facilitates automating one or more features of the system.

24. An apparatus that facilitates mobile device charging and networking, comprising:
an embedded server operative to execute a set of server instructions, the server instructions include an operating system;
a plurality of charging slots, wherein the charging slots include a charging connection and a data connection, the charging connection provides power to recharge an associated mobile device or battery inserted in one of the charging slots, and the data connection provides a direct data link between the server and the associated mobile device;
a data store that maintains at least one of a set of authorization data, at least one service, or data acquired from a mobile device;
a fingerprint scanner that images a user's fingerprint to verify authorization to use a mobile device associated with the apparatus; and
an Ethernet port that provides communication between the apparatus and a communication framework.

25. The apparatus of claim 24, further comprising a charging slot indicator that displays at least one of a charge state of the mobile device inserted in the charging slot, or a status of a mobile device inserted in the charging slot.

26. The apparatus of claim 24, further comprising a liquid crystal diode (LCD) screen that displays at least one of at least one of a set of mobile device information, one or more user login messages, or a system status.

27. The apparatus of claim 24, wherein the server can acquire at least one of one or more services, a set of administration data, or data relating to an associated mobile device via the communication framework.

28. The apparatus of claim 24, wherein the fingerprint scanner verifies user authorization by comparing the imaged fingerprint with authorization data maintained on the storage cards or remotely.

29. The apparatus of claim 24, wherein the data store is at least one of: at least one storage card, a hard drive, or flash memory.

30. The apparatus of claim 29, wherein the storage cards are at least one of: a CF card, a SD card, a micro SD card, a smart card, or removable flash memory.

31. The apparatus of claim 24, wherein the operating system is Linux based.

32. A system for mobile device charging and communication, comprising:
means for charging at least one mobile device's power source;
means for networking the mobile devices with the charging means;
means for communicating with mobile devices networked with the charging means; and
means for authenticating a user and assigning one of the networked mobile devices to the user if they can be authenticated.

33. The system of claim 32, wherein the means for communicating with the mobile devices further includes means for at least one of: monitoring at least one of charge state, or availability of the mobile devices, or pushing at least one of software updates or data to the mobile devices.
